(19) United States
(12) Patent Application Publication
(10) Pub. No.: US 2004/0140327 A1
(43) Pub. Date: Jul. 22, 2004

(54) Pressurized fluid dispenser

(76) Inventors: Michael D. Osborne, Asheville, NC (US); Richard M. Nallenweg, Weaverville, NC (US)

Correspondence Address: GENERAL CHEMICAL PERFORMANCE PRODUCTS LLC., 90 EAST HALSEY ROAD, PARSIPPANY, NJ, 07054, US

(21) Appl. No.: 10/337,433

(22) Filed: Jan. 2, 2003

(51) Int. Cl. B67D 5/42

(52) U.S. Cl. 222/386.5; 222/389; 222/608

(57) ABSTRACT

A readily portable tank type pressurized working fluid dispenser is provided. The tank dispenser contains an internal membrane as separator that functions to isolate the working fluid to be dispensed from the pressurizing delivery fluid, e.g., compressed air, that vents the servicing fluid.

The dispenser that can be readily pre-loaded with working fluid, such as motor oil, and pre-pressurized gas, to provide a fully self contained portable servicing tool. The working fluid is replenishable when exhausted. The tank of the unit contains an internal flexible membrane that isolates a working (servicing) liquid from pressurized gas both confined in the tank. The unit may be secured at a convenient location for periodic scheduled servicing or mounted to a manual movable wheeled tank unit. The pressurizing fluid, usually air is maintained for the capacity of working fluid and no additional addition of air is required to dispense the full quantity of the working fluid carried in the tank.

This invention relates to pressurized tank type fluid dispensers and preferably, in particular the invention relates to a self-contained readily portable working fluid dispenser.

### BACKGROUND OF THE INVENTION

Typical pressurized commercial fluid dispenser used for dispensing working fluids, such as, water or lubricating oil, consist of a tank partially filled with the working fluid. Pressurized air is introduced into the tank to exert the working fluid e.g. the liquid is then dispensed from the tank by the effect of being pushed out by the pressurized air. Tanks of this kind may be of a mobile type that are mounted on wheels to facilitate movement of the unit to the servicing site. Units of this kind frequently are used in the lubrication industry to deliver petroleum lubrication products such as oil and/or grease commonly for example is servicing motor vehicles.

The known, currently used dispensers suffer from several disadvantages that limit a broader usage and also to the application of units of this type to a wider spectrum of servicing functions. Notable among the disadvantages of the known units are the following:

1. The tank must be frequently or constantly recharged with pressurized air to dispense acceptably.

2. The units are devised so air can mix with the liquid producing frothy mixture of air and liquid. This air/liquid mixture produces incorrect readings on the positive displacement fluid flow meters. Positive displacement flow meters will register air flow, fluid flow, or any combination of air or fluid flow. It is undesirable to register air flow when the user is trying to dispense a fixed amount of liquid. This is especially a concern when the tank is nearly empty of fluid. As air begins to be dispensed, the steady stream of fluid is interrupted and the dispenser begins to stutter and spit, which can also produce undesirable splashing and spraying.

3. The compressed air to affect the dispensing pressure often contains water vapor and moisture. This water is carried into the tank, thus contaminating the lubrication fluid and introducing a source of corrosion.

### SUMMARY OF THE INVENTION

The primary objective of the invention is to provide a tank type mobile pressurized fluid dispenser that contains an internal membrane as separator which functions to isolate the fluid to be dispensed from the delivery fluid i.e. from the fluid e.g. compressed air, that is used to propel and discharge the servicing fluid.

It is a more particular objective of the invention to provide a readily portable tank dispenser conditioned for immediate dispensing of the working fluid. The contemplated dispenser can be readily pre loaded or pre-pressurized by the manufacturer or distributor and contains the servicing fluid as well as the pressurized gas, which is effective in propelling i.e. dispensing the servicing fluid from the tank.

It is a more particular and preferred objective of the invention to provide a mobile/portable self contained tank that contains an internal flexible membrane that isolates a working (servicing) liquid from a pressurized gas both confined in the tank and wherein the fast function as a means to deliver the servicing liquid.

It is still a further objective of this invention to a manual movable wheeled tank unit which contains an internal impermeably separator to create separate chambers and thereby to isolate two fluids and wherein the pressure fluid, e.g. air is introduced into one of the chambers of the tank only once, i.e., during initial precharge. The tank is the fully operable and capable of being delivered to the working site for immediate use. The pressurizing fluid, usually air is sufficient to maintain appropriate pressure to deliver the working fluid for the life of the tank and no additional air input is required to dispense the total capacity, i.e., the full quantity of the working fluid carried in the tank. The unit is equipped so that the content of the working fluid when used can be replenished.

Advantages of the dispensing unit of the invention include:

1. The pressuring delivery fluid, i.e., Compressed air is never needed after the initial precharge is established.

2. The presurring fluid, e.g., air and the fluid to be dispensed will not mix, thus meter readings will not be incorrect.

3. Moisture or water vapor contained in the compressed air will not mix with the fluid to be dispensed, thus preventing contamination.

The invention is particularly beneficial when used with a working fluid, such as expensive synthetic oils, where water contamination adversely affects the lubrication properties of fluids of this kind. Also, the invention is especially useful and a convenient tool for motor vehicle servicing facilities.

### BRIEF DESCRIPTION OF THE DRAWING

FIG. 1 is a diagrammatic perspective view of a preferred embodiment of the invention illustrating the fluid dispensing tank mounted on a readily movable assembly.

FIG. 2 is illustrates the embodiment of the tank of FIG. 1 in cross-section without the portable wheeled dolly.

FIG. 3 is a perspective view of a preferred embodiment of the invention illustrating the fluid dispensing tank mounted on a readily movable assembly.

FIG. 4 is another perspective view of a preferred embodiment of the invention shown in FIG. 3 With the working fluid outlet hose disconnected from the fluid exit port.

FIG. 5 is another perspective view of a preferred embodiment of the invention shown in FIG. 3 illustrating the outlet feed hose connected to the working fluid exit port.

### DETAILED DESCRIPTION OF THE INVENTION

For various applications there exists a need for a portable self-contained unit which delivers a servicing fluid under pressure as such for example is the use to lubricate factory machinery e.g. in paper or textile mills in which maintenance is a constant obligation. One particular wide spread usage of the invention is in auto dealership and servicing facilities for dispensing automobile lubricating oil.

As will be apparent from the detailed description which follows for convenience the unit of the invention preferably takes the form of a mobile pressurized fluid dispenser. The pressurized fluid, hereinafter referred to as “air” and the working fluid, for covenience hereinafter referred to as “lubrication fluids”, are separated by a tough flexible bladder or diaphragm. The fluids are introduced to the tank by conventional means, such as, by the use of a pump. The pump is connected to the tank by means of a quick disconnect coupling. After filling the tank with the pressurizing air and with the working fluid, the pump is disconnected from the tank, thus making the tank fully portable. The fluid is then dispensed as needed by being pushed out, i.e.; ejected by the pressure of the precharged air acting on the working fluid via the bladder which separates the air from the working fluid. It is necessary to introduce air into the pressurizing side of the tank only one time during the initial precharge, the air precharge being maintained for the life of the tank and no additional addition of air is required to dispense the totality of the working fluid.

The dispenser tank of the invention employs an internal separation air diaphragm which is impermeably to the liquid and gas. The impermeability of the diaphragm is such that after the initial precharge of air is established, the air and working fluid dispensed do not mix even under substantial pressure. This assures that meter readings of the quantity of working fluid dispensed will not be incorrect. Because air invariably contains moisture and can be absorbed into the working fluid the isolating separation impermeable diaphragm feature of the invention is important. This is because in many applications it is critical that water vapor and/or air in the compressed air not mix with and contaminate the fluid to be dispensed.

The impermeable diaphragm or membrane located internally within the tank comprises a partition sheeting of any of the various know flexible composition which is inert to the fluids with which it is in contact in the tank. Diaphragm compositions of this kind, are known, and include for example those employed for o-ring seals. One composition that may be suitably employed in an acylonitule-butadiene-elastomer, also referred to as is nitrite rubber (NBR), such as the composition available from the Parker Hannifin Corporation of Lexington, Ky.

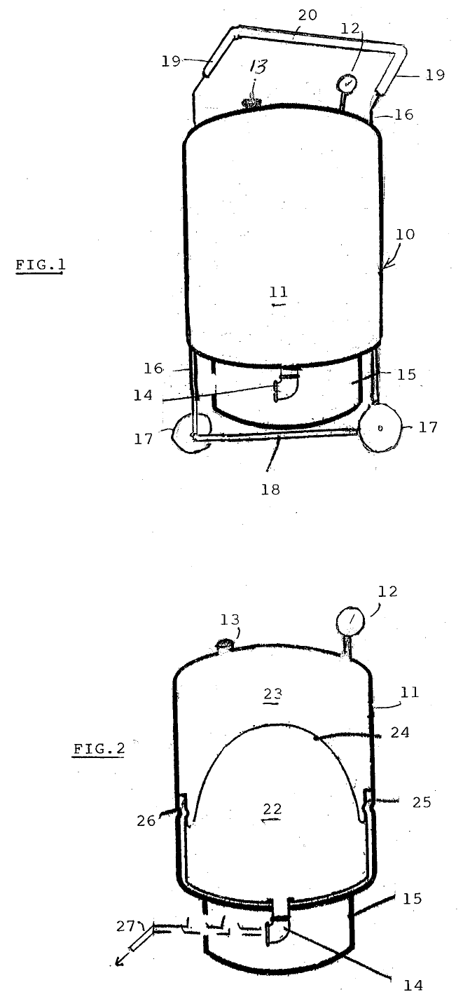

Referring to the embodiment illustrated by FIG. 1 of the drawing, a portable unit 10; comprising a sealed tank 11; equipped with a pressure indicating gauge 12; a gas pressure charging inlet 13; and working fluid dispensing outlet 14, surrounded by a lower protective skirt 15 and mounted on a dolly 16.

The wheeled dolly to facilitate portability comprises a conventional arrangement on which the tank 11 is suitably secured. As shown the dolly comprises a frame 16, wheels 17, connected by an axle 18. The frame extension 19 comprises the handle 20 and assist in facilitating the movement of the unit 10.

It is apparent that while the tank 11 as shown in FIG. 1 is mounted on and carried by a dolly, the tank 11 without the dolly arrangement can be fixedly mounted or removable mounted without the wheeled dolly and for example placed and where desired detachable on an immobile receptacle and from which it can be replenished or recharged periodically with working fluid by a disconnectable coupling means. For example in such usage the tank may be removed, reserviced with pressurizing and working fluid by a distributor, which may take place by a scheduling arrangement and the tank returned full to the customer's (servicing) site. In this way, the fully charged dispensers may be delivered to a user as needed and the empty dispensers can be removed by the servicing distributor to be recharged with fluid and returned to the user at a later time or the tank may be replenished on site as needed with a fresh quantity of working (servicing) fluid.

Referring to FIG. 2 of the drawing the tank unit 11 shown in cross-section illustrates the internal arrangement comprising an upper pressure chamber 23 which contains the pressurizing gas most commonly air and the working fluid chamber 22 separated by the flexible diaphragm 24 which is securely and completely sealed at the periphery of the diaphragm (shown at 25 and 26) so as to thoroughly sealingly isolate the working fluid in chamber 22 from the pressurizing gas in chamber 23.

In filling the tank 11 in practice, the tank is serviced by introducing pressurized air in chamber 23. This can be effected by the tank manufacturer, when to be used, lubrication fluid recharged into chamber 22 which is separated by a bladder or diaphragm 24. The pressurizing air may be introduced to chamber 23 of the tank by a pump connected to the tank via port 13. The servicing fluid is charged through port 14 via a suitable coupling which is then disconnected thus making the tank fully portable.

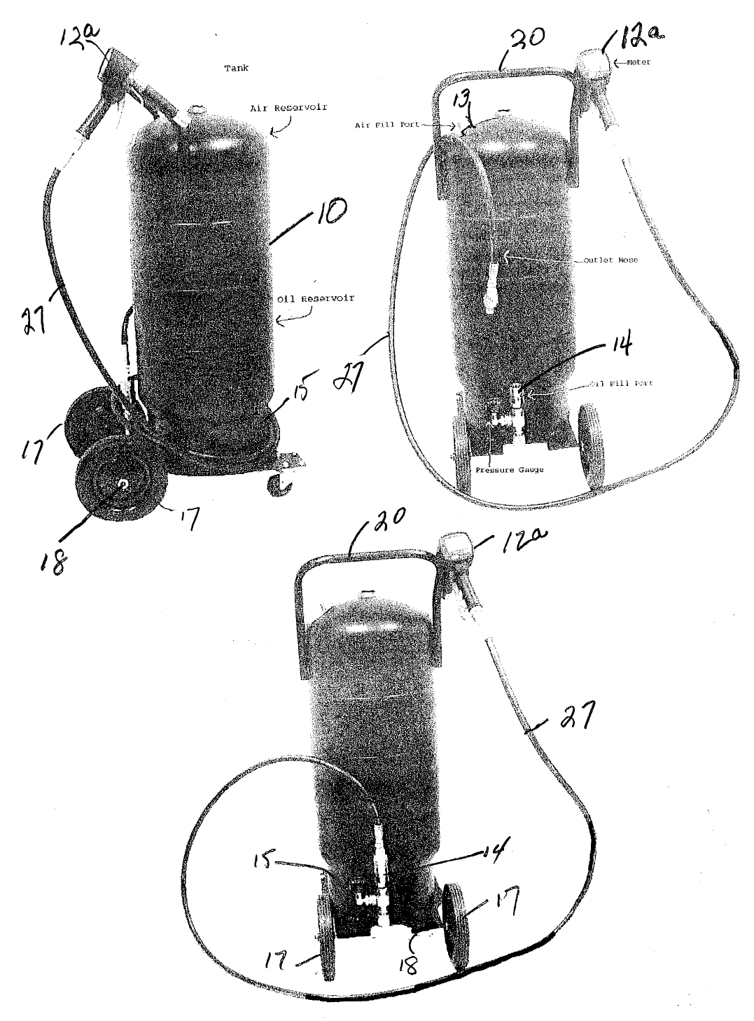

FIGS. 3 and 4 shows the configurations applicable when filling the tank i.e., charging servicing fluid into the chamber 22 of the tank 10 through the port 14. The outlet hose 27 is disconnected from the quick disconnect at port 14. The filling pump (not shown) is then connected to a quick disconnect coupling at 14 and used to fill (under pressure) chamber 22 with working fluid. The working fluid chamber is filled until a predetermined pressure is obtained as read on a pressure gauge or meter. A metering device may be carried on the tank itself as shown in FIG. 1, or preferably as shown at 12a on the dispensing hose 27. A suitable pressure is typically 100 psi. In general, with respect to pressure gauges or metering devises, although a gauge 12 is depicted schematically in FIGS. 1 and 2 which may be used to monitor the pressure in either chambers 22 or 23, only gauge 12a shown in FIGS. 3-5 which meters the servicing fluid being dispensed from chamber 22 is required for most uses of the tank assembly of the invention. When the dispensing (chamber 22) is fully charged with working fluid, such as a lubricant, the filling pump is disconnected from port 14. The outlet hose is reattached to port 14 as shown in FIG. 5. The fluid is then dispensed as needed via outlet port 14 by means of being pushed out by the force of pressure on the working fluid in chamber 22 and the quantity measured on the meter 12a. The Air pressure precharge in chamber 23 acting on the bladder which separates the air from the fluid provides the appropriate force to dispense the working fluid. Air i.e., the pressure producing force need be introduced into the air side of the tank (chamber 23 of FIG. 2) only one time during an initial precharge. This pre-charge is then maintained for the life of the tank and no additional quantity of air is ordinarily required to provide the needed pressure to feed the working fluid.

It will be apparent to those skilled in the art that various alternative embodiments may be made to the unit shown without departing from the invention. For example the dispensing tank of the invention may comprise an internal vertically disposed diaphragm and may even include a three-chamber unit not shown comprising two working fluid dispensing chambers pressurized by a third driving pressure filled chamber.

What is claimed is:

1. A portable unit for delivering servicing fluid under pressure comprising:
an enclosed gas and liquid confining tank; containing at least two isolated chambers;
a first chamber to confine a dispensing pressure fluid in said tank;
a second chamber to confine a servicing fluid to be dispensed
each chamber being separated from a contingous chamber by a gas and liquid impermeable flexible diaphragm;
a pressurizing fluid confined in said first chamber to exert a dispensing pressure for said servicing fluid;
inlet means to introduce a servicing fluid into at least a second chamber;
outlet means for delivering servicing fluid from said second chamber said servicing fluid being dispensed by the pressure exerted via said diaphragm of the fluid contained in the first chamber; and
fluid metering means associated with said unit.

2. A unit according to claim 1 which is mounted on a dolly to facilitate movement of the unit.

3. A unit according to claim 1 comprising gas in the first chamber and for containing a lubricant servicing fluid in the second chamber.

4. The unit of claim 2 comprising a first air pressure containing chamber and a second lubricant-containing chamber.

5. A unit according to claim 1 which the outlet means is equipped with a dispensing hose equipped with a quick disconnected coupling for said service fluid outlet means.

6. A unit according to claim 1 provided with a pressure servicing fluid detecting gauge on said tank.

7. The unit according to claim 5 in which the dispensing hose is provided with a metering gauge.

8. A unit according by claim 7, wherein the metering gauge comprises a flow meter to measure the volume of dispensed servicing fluid

9. A unit according to claim 1 wherein the metering means comprises a gauge to measure the pressure of the pressurizing fluid.

10. A unit according to claim 8 equipped with a gauge to measure the pressure of the remaining quantity of the contained servicing fluid.

11. A unit according to claim 3 comprising of an automotive servicing apparatus in which the first chamber contains pressurized air and the second chamber contains a lubricant.
